(19) United States
(12) Patent Application Publication
(10) Pub. No.: US 2026/0004447 A1
(43) Pub. Date: Jan. 1, 2026

(54) DISPLAY DEVICE

(71) Applicant: TOYOTA JIDOSHA KABUSHIKI KAISHA, Toyota-shi (JP)

(72) Inventors: Kazuhisa ISHIMARU, Nagoya-shi (JP); Go MATSUNOBU, Okazaki-shi (JP)

(73) Assignee: TOYOTA JIDOSHA KABUSHIKI KAISHA, Toyota-shi (JP)

(21) Appl. No.: 19/095,333

(22) Filed: Mar. 31, 2025

(30) Foreign Application Priority Data
Jun. 28, 2024 (JP) 2024-104941

(51) Int. Cl. G06T 7/70; B60R 1/24; G01S 13/86; G01S 13/931; G06T 11/00; G06V 20/58

(52) U.S. Cl. CPC G06T 7/70; B60R 1/24; G01S 13/867; G01S 13/931; G06T 11/00; G06V 20/58; B60R 2300/301; B60R 2300/308; G06T 2207/30252; G06V 2201/08

(57) ABSTRACT

A display device includes a recognition generation unit that performs vehicle recognition based on detection results of a camera and radar sensors and generates a virtual image for superimposition including a vehicle image representing another vehicle, and a display control unit that displays the virtual image for superimposition on a display unit of the vehicle. The recognition generation unit calculates an image recognition position using an image captured by the camera, calculates an integrated position using the detection results of the camera and the radar sensors and corrects the integrated position so as to make the integrated position closer to the image recognition position to calculate a corrected integrated position. The display control unit corrects the position of the vehicle image in the virtual image for superimposition based on a distance measurement value to the other vehicle using the radar sensors, the integrated position, and the corrected integrated position.

### CROSS-REFERENCE TO RELATED APPLICATION

This application claims priority to Japanese Patent Application No. 2024-104941 filed on Jun. 28, 2024, incorporated herein by reference in its entirety.

### BACKGROUND

### 1. Technical Field

The disclosure relates to a display device.

### 2. Description of Related Art

Japanese Unexamined Patent Application Publication No. 2023-136363 (JP 2023-136363 A) describes an image projection device that projects a projection image onto a windshield for displaying a virtual image that is, for example, a forward display image for attracting attention or the like.

### SUMMARY

For example, it is considered to recognize a vehicle image representing another vehicle ahead of an own vehicle based on detection results of a camera and a radar sensor to be used for driver assistance, autonomous driving or the like, and display the virtual image including the vehicle image while the virtual image is superimposed on a display portion of the own vehicle.

When the vehicle image representing another vehicle ahead of the own vehicle is recognized, the detection results of both the camera and the radar sensor may be used (fused) to calculate an integrated position that is a position of the vehicle image in the virtual image for superimposition and a position on a predetermined plane on which the own vehicle is present. When the actual position of the other vehicle is not on the predetermined plane like such a case that a road ahead of the own vehicle has a slope or the like, the position of the vehicle image in the virtual image for superimposition is misaligned with an image recognition position recognized by using an image captured by the camera. For this reason, the integrated position may be corrected to be close to the image recognition position.

However, for example, in recognition of another vehicle existing near the own vehicle, when there is a pattern that is confusingly similar to the feature of the other vehicle, there is a risk that erroneous recognition may occur at the image recognition position using an image captured by the camera. As a result, there is a risk that the position corrected so as to make the integrated position closer to the image recognition position may be misaligned with the actual position of the other vehicle.

A display device according to an aspect of the present disclosure includes a recognition generation unit that performs vehicle recognition based on detection results of a camera that captures an image ahead of an own vehicle and a radar sensor that detects objects around the own vehicle, and generates a virtual image for superimposition including a vehicle image representing another vehicle ahead of the own vehicle recognized by the vehicle recognition, and a display control unit that displays the virtual image for superimposition on a display unit of the own vehicle, wherein the recognition generation unit calculates an image recognition position that is a position of the vehicle image in the virtual image for superimposition, by using a position of the other vehicle in the image captured by the camera, calculates an integrated position that is a position of the vehicle image in the virtual image for superimposition and is also a corresponding position on a predetermined plane on which the own vehicle is present, by using detection results of both the camera and the radar sensor, and calculates a corrected integrated position that is the position of the vehicle image in the virtual image for superimposition and that also corresponds to an actual position of the other vehicle relative to the own vehicle, by correcting the integrated position so as to make the integrated position closer to the image recognition position, and wherein the display control unit corrects the position of the vehicle image in the virtual image for superimposition based on a distance measurement value to the other vehicle using the radar sensor, the integrated position, and the corrected integrated position.

In the display device according to the aspect of the present disclosure, the position of the vehicle image in the virtual image for superimposition is corrected based on the distance measurement value to the other vehicle using the radar sensor, the integrated position, and the corrected integrated position. Therefore, in recognition of another vehicle near the own vehicle, it is possible to correct the position of the vehicle image in the virtual image for superimposition according to the distance from the own vehicle to the other vehicle. This makes it possible to restrain the influence of erroneous recognition that may occur in the image recognition position using the image captured by the camera as compared with, for example, a case where a corrected integrated position that has been corrected such that the integrated position is closer to the image recognition position regardless of the distance from the own vehicle to the other vehicle is uniformly used.

In one embodiment, the display control unit may correct the position of the vehicle image in the virtual image for superimposition such that the position of the vehicle image in the virtual image for superimposition is closer to the corrected integrated position as the distance measurement value increases, and correct the position of the vehicle image in the virtual image for superimposition such that the position of the vehicle image in the virtual image for superimposition is closer to the integrated position as the distance measurement value decreases. In this case, when the influence of erroneous recognition is unlikely to occur in the image recognition position using the image captured by the camera, it is possible to use a corrected integrated position that has been corrected to be closer to the image recognition position. Furthermore, when the influence of erroneous recognition is likely to occur in the image recognition position using the image captured by the camera, it is possible to use an integrated position that has not been corrected to be closer to the image recognition position, thereby restraining the influence of erroneous recognition that may occur in the image recognition position.

In one embodiment, the display control unit may calculate a virtual road surface gradient along a virtual line connecting the own vehicle and the actual position of the other vehicle relative to the own vehicle based on an intersection angle between the virtual line and the predetermined plane, and correct the position of the vehicle image in the virtual image for superimposition when the virtual road surface gradient is equal to or less than a predetermined upper limit gradient threshold value. In this case, when another vehicle ahead of the own vehicle is present on a road within a realistically possible gradient range, the position of the vehicle image in the virtual image for superimposition can be corrected.

According to the present disclosure, the position of a vehicle image representing another vehicle ahead of an own vehicle in a virtual image for superimposition can be restrained from being influenced by erroneous recognition that may occur in an image recognition position using an image captured by a camera.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a configuration of a display device according to an embodiment;

FIG. 2A is a diagram showing an example of a virtual image in which an image recognition position and an integrated position are superimposed;

FIG. 2B is a diagram showing an example of a virtual image on which a corrected integrated position is superimposed;

FIG. 3 is a diagram showing an example of misalignment in the corrected integrated position;

FIG. 4 is a diagram showing another example of misalignment in the corrected integrated position;

FIG. 5 is a diagram showing a correction ratio to be used in an example of correction of the position of a vehicle image;

FIG. 6 is a diagram showing an example in which the position of the vehicle image in FIG. 3 has been corrected;

FIG. 7 is a diagram showing an example of a situation in which a virtual road surface gradient exceeds a predetermined upper limit gradient threshold value; and

FIG. 8 is a flowchart showing a processing example by the display device according to the embodiment.

### DETAILED DESCRIPTION OF EMBODIMENTS

An embodiment of the present disclosure will be described hereunder with reference to the drawings.

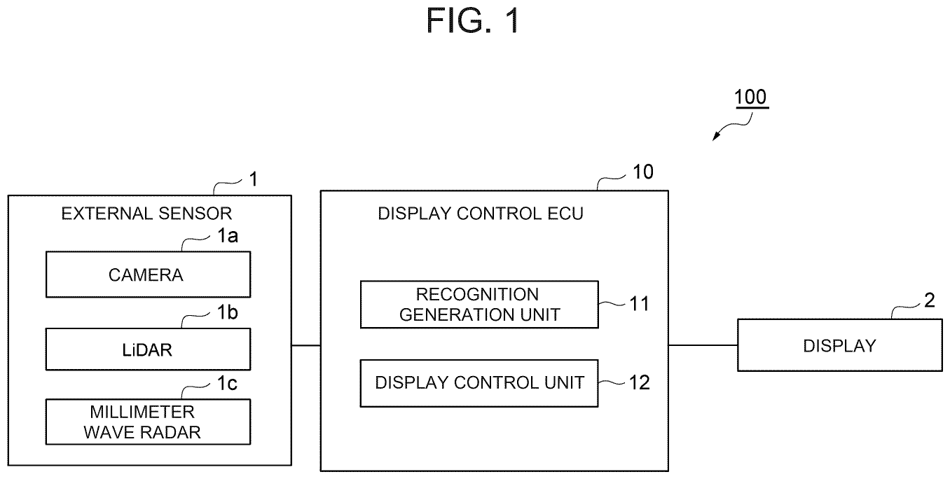

FIG. 1 is a block diagram showing a display device 100 according to an embodiment. The display device 100 shown in FIG. 1 is a device that is installed in a vehicle such as a passenger car or a freight car (hereinafter referred to as own vehicle) and displays an image matching a condition around the own vehicle. The own vehicle may have a driver assistance function such as an adaptive cruise control (ACC), or may have an autonomous driving function including vehicle speed control.

As shown in FIG. 1, the display device 100 includes a display control electronic control unit (ECU) 10 for integrally managing the device. The display control ECU 10 is an electronic control unit having a central processing unit (CPU) and a storage unit. The storage unit is configured by, for example, a read only memory (ROM), a random access memory (RAM), and an electrically erasable programmable read-only memory (EEPROM) or the like. The display control ECU 10 implements various functions, for example, by executing a program stored in the storage unit with the CPU. An external sensor 1 and a display 2 (display unit) are connected to the display control ECU 10. The display control ECU 10 may be configured by a plurality of electronic units.

The external sensor 1 is a detection device that detects the surrounding condition of the own vehicle. The external sensor 1 includes a camera 1a that captures an image ahead of the own vehicle, and a radar sensor.

The camera 1a is an imaging device that captures an image ahead of the own vehicle. The camera 1a is provided, for example, on the backside of the windshield of the own vehicle, and captures an image ahead of the own vehicle. The types of the camera 1a include, for example, a telephoto camera, a wide-angle camera, a monocular camera, a stereo camera, and the like. The stereo camera has two imaging units arranged to reproduce binocular parallax. Imaging information of the stereo camera also includes information in the depth direction. The camera 1a transmits information about a captured image to the display control ECU 10.

The radar sensor is a detection device that detects objects around the own vehicle using radio waves (for example, millimeter waves) or light. The radar sensor detects objects by transmitting radio waves or light to the surroundings of the own vehicle and receiving the radio waves or light reflected by the objects. Examples of the radar sensor include light detection and ranging (LiDAR) 1b, a millimeter wave radar 1c, and the like. The radar sensor may acquire measured distance values to the objects (other vehicles, etc.) around the own vehicle. The radar sensor transmits information on the detected objects and the acquired measured distance values to the display control ECU 10. In the following description, the radar sensor including at least one of LiDAR 1b and the millimeter wave radar 1c is collectively referred to simply as “radar sensors 1b, 1c”.

The display 2 is a display device provided in the vehicle cabin of the own vehicle. A head-up display (HUD) is used as an example of the display 2. The display 2 may be configured as an AR-HUD for projecting an image onto the display surface of the front windshield by using an augmented reality (AR) technique or the like. The display area of the head-up display is an area preset on the front windshield, and is a range in which a virtual image is projected to be displayed while superimposed. The display 2 is controlled to display various information in response to a control signal from the display control ECU 10. A virtual image including a vehicle image representing another vehicle is displayed on the display 2 while superimposed on an image representing circumstances ahead of the own vehicle.

Next, the functional configuration of the display control ECU 10 will be described. The display control ECU 10 includes a recognition generation unit 11 and a display control unit 12.

The recognition generation unit 11 performs vehicle recognition based on detection results of the camera 1a that captures an image ahead of the own vehicle and the radar sensor 1b that detects objects around the own vehicle. With respect to the vehicle recognition, the recognition generation unit 11 recognizes another vehicle ahead of the own vehicle, for example, by calculating an image recognition position, an integrated position, and a corrected integrated position. The other vehicle is, for example, a vehicle that is traveling precedingly ahead of the own vehicle. The other vehicle is not limited to a four-wheeled vehicle, and may be a two-wheeled vehicle.

The image recognition position is the position of the vehicle image in the virtual image for superimposition calculated by using the position of the other vehicle in the image captured by the camera 1a. The recognition generation unit 11 can calculate the image recognition position by performing known image recognition on the image captured by the camera 1a, for example, by deep learning or the like.

The integrated position is a result of so-called FSN (fusion) recognition calculated by using the detection results of both the camera 1a and the radar sensors 1b, 1c. The integrated position is, for example, a position of the vehicle image in the virtual image for superimposition and a corresponding position on a predetermined plane on which the own vehicle is present. The predetermined plane may be assumed to be, for example, a horizontal plane (a plane having no gradient) on which the own vehicle is present. The recognition generation unit 11 can calculate the integrated position by performing a known FSN recognition. The known FSN recognition means a known object recognition method in which the relative position of another vehicle calculated based on an image captured by the camera is corrected by using a detection result of another sensor having higher distance measurement accuracy than the camera. For example, when there is a combination of other vehicles satisfying a predetermined positional relationship that is determined to belong to the same object among other vehicles recognized from the image captured by the camera 1a and other vehicles recognized from the detection results of the radar sensors 1b, 1c, the recognition generation unit 11 combines (fuses) information pieces representing the other vehicles of the combination to generate a fusion object as a combined object. Furthermore, “the relative position of another vehicle calculated based on an image captured by the camera” to be subjected to FSN recognition is not limited to “a corresponding position on a predetermined plane on which the own vehicle is present” as in the present embodiment, but it may be, for example, the relative position of another vehicle calculated with lower distance measurement accuracy than other sensors as a result of the camera having a wide viewing angle.

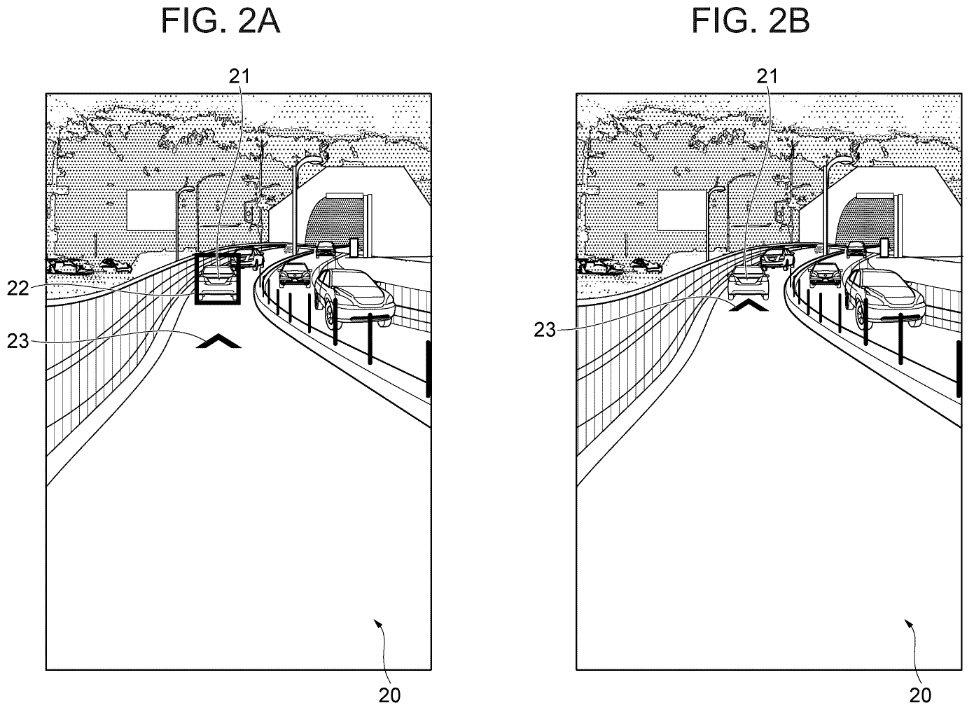

The recognition generation unit 11 generates a virtual image for superimposition including a vehicle image representing another vehicle ahead of the own vehicle recognized by vehicle recognition. FIG. 2A is a diagram showing an example of a virtual image (virtual image for superimposition) in which an image recognition position and an integrated position are superimposed. In FIG. 2A, circumstances ahead of the own vehicle as seen from the own vehicle are shown as a virtual image for superimposition 20 to be projected on the display 2. In FIG. 2A, with respect to a vehicle image 21 of another vehicle traveling ahead of the own vehicle, an image recognition position is indicated by a solid-line frame 22, and an integrated position is indicated by a solid-line marker 23. The marker 23 may be indicated, for example, by the shape of “\hat{ }”.

In the example of FIG. 2A, the marker 23 is located below the lower end portion of the solid-line frame 22. The positional misalignment is caused because a road in FIG. 2A has, for example, an upward slope, and thus the position of the marker 23 in the virtual image for superimposition 20 set to the corresponding position on the predetermined plane having no gradient is set to a position that does not correspond to the actual position of the other vehicle located on the road having a slope. In the example of FIG. 2A, the position of the other vehicle located on the road having a slope corresponds to the position of the solid-line frame 22 surrounding the vehicle image 21 in the virtual image for superimposition 20. In the following description, “the position” in the virtual image for superimposition corresponds to the position in a depth direction ahead of the own vehicle, and means the coordinate position in the up-down direction in the virtual image for superimposition.

FIG. 2B is a diagram showing an example of the virtual image on which a corrected integrated position is superimposed. In the example of FIG. 2B, the corrected integrated position is indicated by a marker 23 that is shifted from the solid-line marker 23 in FIG. 2A. The corrected integrated position is calculated by correcting the integrated position (solid-line marker 23) in FIG. 2A such that the integrated position is closer to the image recognition position (solid-line frame 22), for example, by a known correction method based on the difference in the up-down direction between the coordinates of the frame 22 and the marker 23 in the virtual image for superimposition 20. The corrected integrated position is the position of the vehicle image in the virtual image for superimposition 20 (for example, the display lower end position of the solid-line frame 22), and corresponds to the actual position of the other vehicle relative to the own vehicle. Such a corrected integrated position can be said to be a position corrected with high accuracy when the error of the superimposed image recognition position calculated using the position of the other vehicle in the image captured by the camera 1a is small.

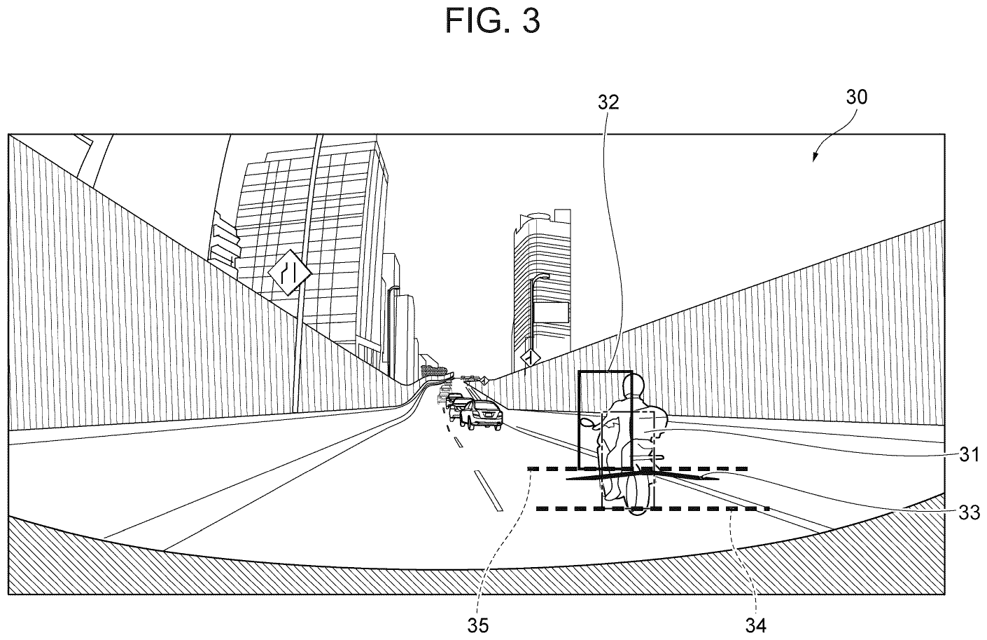

FIG. 3 is a diagram showing an example of the misalignment of the corrected integrated position. In FIG. 3, circumstances ahead of the own vehicle as seen from the own vehicle in a scene different from that in FIG. 2A and FIG. 2B are shown as another example of the virtual image for superimposition 30 to be projected onto the display 2. In the virtual image for superimposition 30 in FIG. 3, a vehicle image 31 representing a motorcycle that is another vehicle traveling ahead of the own vehicle is shown in a lane to the right of the lane in which the own vehicle is traveling. The other vehicle in FIG. 3 is closer to the own vehicle than the other vehicle in FIG. 2A and FIG. 2B. However, for example, in the recognition of another vehicle existing near the own vehicle, when there is a pattern that is confusingly similar to the feature of the other vehicle, there is a risk that erroneous recognition occurs at the image recognition position using an image captured by the camera 1a.

In the example of FIG. 3, the pattern that is confusingly similar to the feature of the other vehicle corresponds to a case where the other vehicle is a motorcycle. Therefore, the image recognition position (solid-line frame 32) is different from a dashed line 34 representing an original position (a position that should be a display lower end position of the lower end of the frame), and it is set to, for example, the position of a dashed line 35 located on the back side of the original position. As a result, the corrected integrated position (marker 33) in FIG. 3 is also set to the position of the dashed line 35 that is on the back side of the original position.

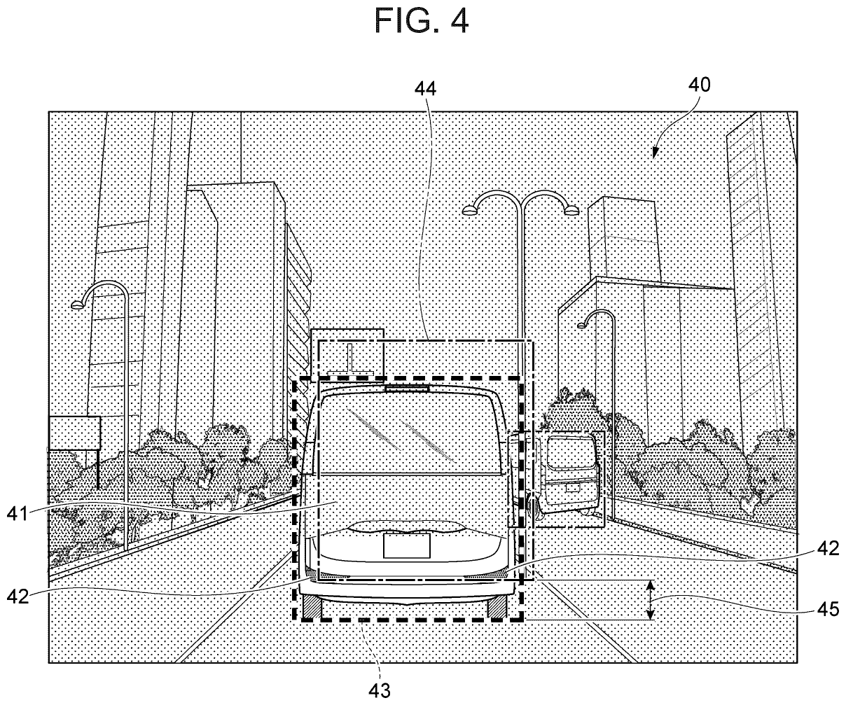

FIG. 4 is a diagram showing another example of the misalignment of the corrected integrated position. In FIG. 4, circumstances ahead of the own vehicle as seen from the own vehicle in a scene different from those in FIG. 2A, FIG. 2B, and FIG. 3 are shown as another example of the virtual image for superimposition 40 to be projected onto the display 2. In the virtual image for superimposition 40 in FIG. 4, for example, a vehicle image 41 representing a minivan that is another vehicle traveling ahead of the own vehicle is shown in the lane in which the own vehicle is traveling at night where the surroundings are dark. The other vehicle in FIG. 4 has a pair of patterns 42 at both the left and right end portions of the rear bumper.

In the example of FIG. 4, the pattern that is confusingly similar to the feature of another vehicle corresponds to a case where a pair of patterns 42 is misidentified as a pair of left and right tires. Therefore, another vehicle is mistakenly recognized as being present at the position of the pair of patterns 42, and the image recognition position is different from the original position (dashed line 43), and it is set to, for example, the position of a one-dotted chain-line frame 44 above the original position. As a result, there is a risk that the corrected integrated position in FIG. 4 may also be higher than the original position by the height of an arrow 45.

Therefore, the display control unit 12 corrects the position of the vehicle image in the virtual image for superimposition based on the distance measurement value to the other vehicle using the radar sensors 1b, 1c, the integrated position, and the corrected integrated position. For example, the display control unit 12 corrects the position of the vehicle image in the virtual image for superimposition such that the position of the vehicle image is closer to the corrected integrated position as the distance measurement value using the radar sensors 1b, 1c increases. Alternatively, the display control unit 12 may correct the position of the vehicle image in the virtual image for superimposition such that the position of the vehicle image is closer to the integrated position as the distance measurement value using the radar sensors 1b, 1c decreases.

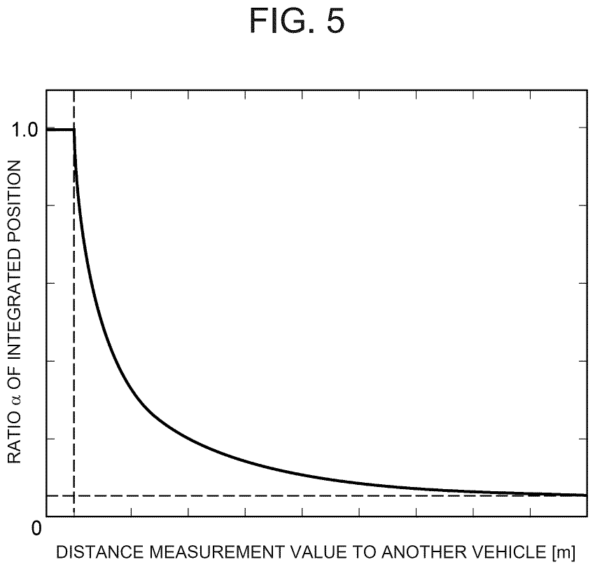

FIG. 5 is a diagram showing a correction ratio to be used in an example of correcting the position of a vehicle image. The horizontal axis of FIG. 5 represents the distance measurement value to another vehicle using the radar sensors 1b, 1c. The vertical axis of FIG. 5 represents the ratio α of the integrated position. The example of FIG. 5 adopts such an inversely proportional formula that the correction ratio α is equal to 1 when the distance measurement value is in the vicinity of 0, the correction ratio α being used in an example of correcting the position of the vehicle image. By applying such a ratio α to the following formula (1), the display lower end position of the vehicle image in the virtual image for superimposition is corrected such that the display lower end position is closer to the corrected integrated position as the distance measurement value increases, and the display lower end position of the vehicle image in the virtual image for superimposition is corrected such that the display lower end position is closer to the integrated position as the distance measurement value decreases.

$$Display lower end position = α \times integrated position + ( 1 - α ) \times corrected integrated position \qquad ( 1 )$$

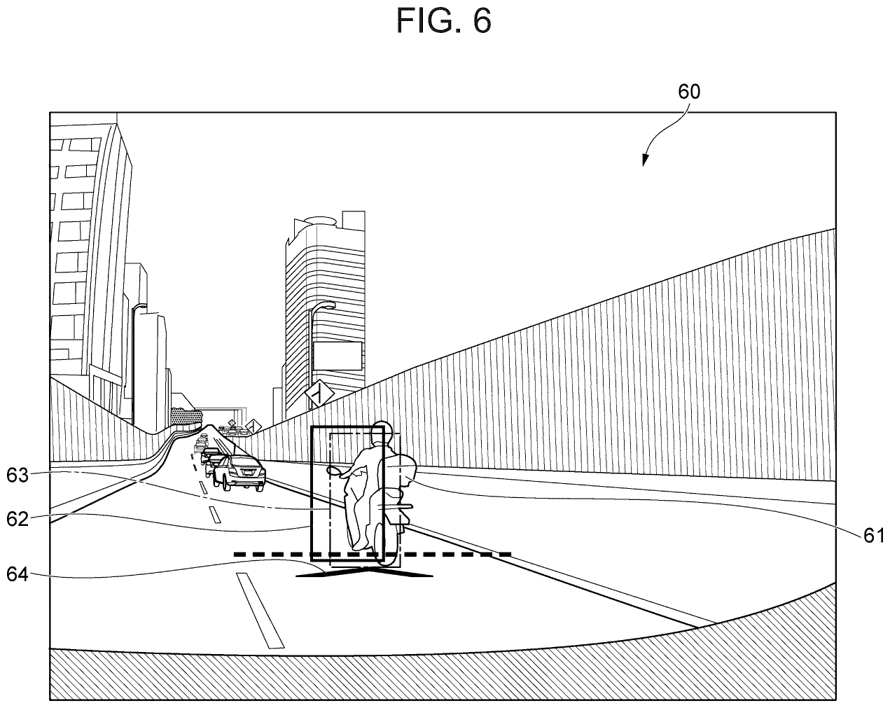

The display control unit 12 causes the display 2 of the own vehicle to display the virtual image for superimposition in which the position of the vehicle image has been corrected. FIG. 6 is a diagram showing an example in which the position of the vehicle image in FIG. 3 is corrected. As shown in FIG. 6, the distance measurement value from the own vehicle to the other vehicle that is a motorcycle is smaller than that in the case shown in FIG. 2A and FIG. 2B. Therefore, the ratio α close to 1 is applied in the formula (1). As a result, the solid-line frame 62 that should surround a vehicle image 61 in the virtual image for superimposition 60 is corrected to be closer to the integrated position (one-dotted chain line 63), and even if erroneous recognition occurs in the image recognition position using the image captured by the camera 1a, it is possible to restrain the marker 64 from being misaligned due to the influence of the erroneous recognition.

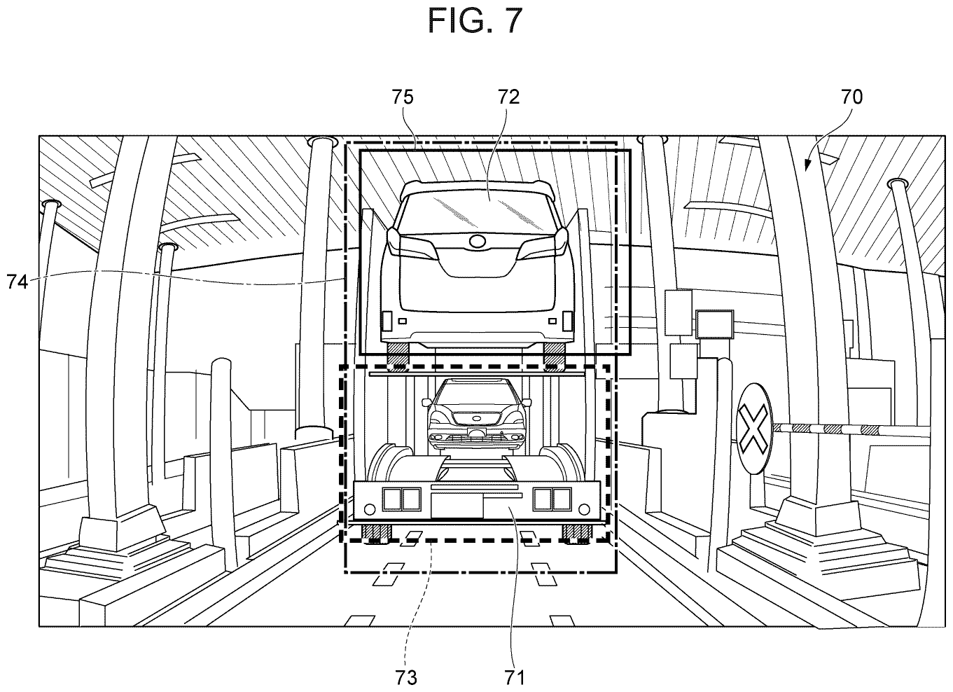

FIG. 7 is a diagram showing an example of a condition in which the virtual road surface gradient exceeds a predetermined upper limit gradient threshold value. In FIG. 7, a minivan 72 is loaded on a loading vehicle 71 traveling ahead of the own vehicle. In image recognition using an image captured by the camera 1a, both the loading vehicle 71 and the minivan 72 may be recognized as “other vehicles ahead of the own vehicle”. However, since the minivan 72 is not traveling on a road, the position of the vehicle image does not need to be corrected.

Therefore, the display control unit 12 may calculate a virtual road surface gradient along a virtual line based on the intersection angle between a predetermined plane and a virtual line that connects the own vehicle and the actual position of another vehicle relative to the own vehicle. If it is assumed that another vehicle ahead of the own vehicle is present on a sloped road surface, the virtual road surface gradient is a value (for example, “%” in unit) corresponding to the gradient of a road surface. For example, for each of the loading vehicle 71 and the minivan 72, the display control unit 12 calculates the intersection angle between the image recognition position acquired by the vehicle recognition using the image captured by the camera 1a and the predetermined plane from the difference in the number of pixels in the captured image, and calculates the virtual road surface gradient from the intersection angle.

When the virtual road surface gradient is equal to or less than a predetermined upper limit gradient threshold value, the display control unit 12 may correct the position of the vehicle image in a virtual image for superimposition 70. The upper limit gradient threshold value is a predetermined gradient threshold value that is preset for determining whether to correct the position of the vehicle image. The upper limit gradient threshold value may be, for example, the value of a longitudinal gradient specified in the Road Structure Ordinance.

When the virtual road surface gradient is equal to or less than the upper limit gradient threshold value, it is highly likely that another vehicle ahead of the own vehicle is actually present on a sloped road surface. Therefore, the position of the vehicle image in the virtual image for superimposition 70 is corrected. On the other hand, when the virtual road surface gradient exceeds the upper limit gradient threshold value, there is no road having such a large gradient in reality, so that it is unlikely that another vehicle ahead of the own vehicle is actually present on a sloped road surface. Therefore, it is not necessary to correct the position of the vehicle image in the virtual image for superimposition 70.

In the example of FIG. 7, a broken line 73 surrounding a loading vehicle 71 is almost entirely contained within one-dotted chain line 74 surrounding the loading vehicle 71 and the minivan 72. Furthermore, the broken line 73 surrounding the loading vehicle 71 is adjacent to a solid line 75 surrounding the minivan 72 in the up-and-down direction. When these conditions continue for a certain period of time or more, the broken line 73 surrounding the loading vehicle 71 may be used as the integrated position.

### Processing of Display Control ECU

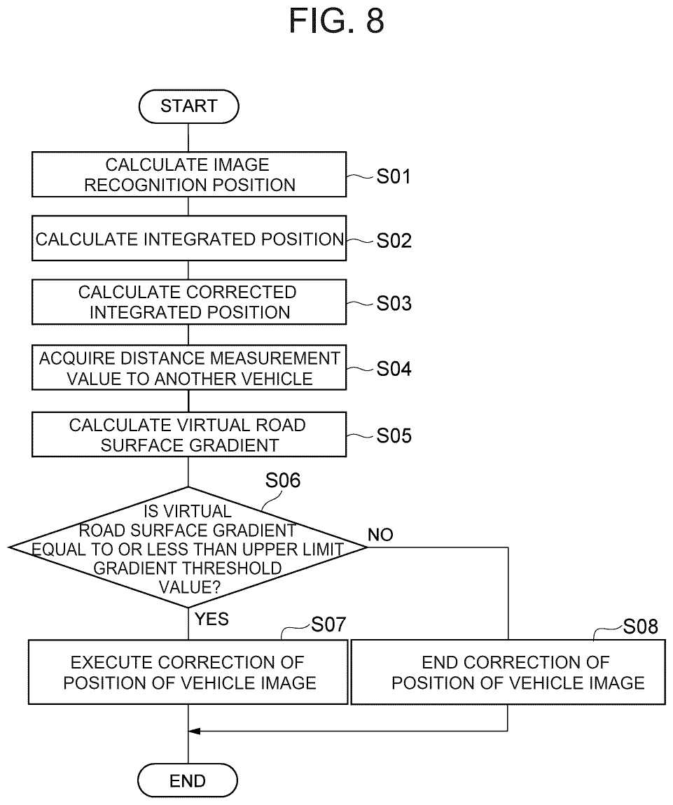

Next, an example of the processing of the display control ECU 10 will be described with reference to FIG. 8. FIG. 8 is a flowchart showing an example of the processing of the display device according to the embodiment. The processing shown in FIG. 8 is repeatedly performed at a predetermined cycle during the operation of the display control ECU 10, for example.

As shown in FIG. 8, the display control ECU 10 calculates an image recognition position by the recognition generation unit 11 in S01. The recognition generation unit 11 uses the position of another vehicle in the image captured by the camera 1a to calculate an image recognition position that is the position of a vehicle image in a virtual image for superimposition.

In S02, the display control ECU 10 calculates an integrated position by the recognition generation unit 11. The recognition generation unit 11 uses the detection results of both the camera 1a and the radar sensors 1b, 1c to calculate the integrated position that is a position of the vehicle image in the virtual image for superimposition and a corresponding position on a predetermined plane on which the own vehicle is present.

In S03, the display control ECU 10 calculates a corrected integrated position by the recognition generation unit 11. The recognition generation unit 11 calculates a corrected integrated position that is the position of the vehicle image in the virtual image for superimposition and that also corresponds to the actual position of another vehicle relative to the own vehicle, by correcting the integrated position so as to make the integrated position closer to the image recognition position.

In S04, the display control ECU 10 acquires a distance measurement value to another vehicle by the recognition generation unit 11. The recognition generation unit 11 acquires a distance measurement value to another vehicle using the radar sensors 1b, 1c by using the detection results of the radar sensors 1b, 1c.

In S05, the display control ECU 10 calculates a virtual road surface gradient by the display control unit 12. The display control unit 12 calculates a virtual road surface gradient along a virtual line connecting the own vehicle and the actual position of another vehicle relative to the own vehicle based on the intersection angle between the virtual line and a predetermined plane.

In S06, the display control ECU 10 determines whether the virtual road surface gradient is equal to or less than a predetermined upper limit gradient threshold value by the display control unit 12. If the display control unit 12 determines that the virtual road surface gradient is equal to or less than the upper limit gradient threshold value (S06: YES), the display control ECU 10 moves to S07. If the display control unit 12 determines that the virtual road surface gradient exceeds the upper limit gradient threshold value (S06: NO), the display control ECU 10 moves to S08.

In S07, the display control ECU 10 executes correction of the position of the vehicle image by the display control unit 12. For example, the display control unit 12 corrects the position of the vehicle image in the virtual image for superimposition such that the position of the vehicle image in the virtual image for superimposition is closer to the corrected integrated position as the distance measurement value increases. Alternatively, the display control unit 12 corrects the position of the vehicle image in the virtual image for superimposition such that the position of the vehicle image in the virtual image for superimposition is closer to the integrated position as the distance measurement value decreases. Thereafter, the display control ECU 10 terminates the processing of FIG. 3.

Furthermore, in S08, the display control ECU 10 causes the display control unit 12 to end the correction of the position of the vehicle image. For the termination of the correction of the position of the vehicle image, the corresponding integrated position on the predetermined plane on which the own vehicle is present may be used. In addition, for the termination of the correction of the position of the vehicle image, previous display may be held for a certain period of time, or, when the correction continues after a certain period of time has elapsed, such a certain forgetting factor that the ratio α in the above formula (1) gradually approaches to 0 is repeatedly multiplied to gradually approach the position of the vehicle image in the virtual image for superimposition to the integrated position. Thereafter, the display control ECU 10 terminates the processing of FIG. 3.

As described above, according to the display device 100, the position of the vehicle image in the virtual image for superimposition is corrected based on the distance measurement value to another vehicle using the radar sensors 1b, 1c, the integrated position, and the corrected integrated position. Therefore, even when another vehicle near the own vehicle is recognized, the position of the vehicle image in the virtual image for superimposition can be corrected according to the distance from the own vehicle to the other vehicle. This makes it possible to restrain the influence of erroneous recognition that may occur in the image recognition position using the image captured by the camera 1a as compared with, for example, a case where the corrected integrated position obtained by correcting the integrated position such that the integrated position is closer to the image recognition position regardless of the distance from the own vehicle to the other vehicle is uniformly used.

In the display device 100, the display control unit 12 corrects the position of the vehicle image in the virtual image for superimposition such that the position of the vehicle image in the virtual image for superimposition is closer to the corrected integrated position as the distance measurement value increases, and corrects the position of the vehicle image in the virtual image for superimposition such that the position of the vehicle image in the virtual image for superimposition is closer to the integrated position as the distance measurement value decreases. As a result, when the distance measurement value is large and the influence of erroneous recognition is unlikely to occur in the image recognition position using the image captured by the camera 1a, it is possible to use the corrected integrated position that has been corrected to be closer to the image recognition position. Furthermore, when the distance measurement value is small and the influence of erroneous recognition is likely to occur in the image recognition position using the image captured by the camera 1a, it is possible to use the integrated position that has not been corrected to be closer to the image recognition position, thereby restraining the influence of erroneous recognition that may occur in the image recognition position.

In the display device 100, the display control unit 12 calculates the virtual road surface gradient along the virtual line connecting the own vehicle and the actual position of another vehicle relative to the own vehicle based on the intersection angle between the virtual line and the predetermined plane, and corrects the position of the vehicle image in the virtual image for superimposition when the virtual road surface gradient is equal to or less than the predetermined upper limit gradient threshold value. This makes it possible to correct the position of the vehicle image in the virtual image for superimposition when another vehicle ahead of the own vehicle is present on a road within a realistically possible gradient range.

The embodiment of the present disclosure has been described above, but the present disclosure is not limited to the above embodiment.

In the embodiment, the display control unit 12 corrects the position of the vehicle image in the virtual image for superimposition when the virtual road surface gradient is equal to or less than the predetermined upper limit gradient threshold value. However, this example is not essential, and may be omitted. In the case where this example is omitted, the display control unit 12 does not need to calculate the virtual road surface gradient along the virtual line.

In the embodiment, the position of the vehicle image is corrected using the ratio α given in inverse proportion as shown in FIG. 5, but this example is not essential. For example, the display control unit 12 may use another monotonically decreasing formula to correct the position of the vehicle image in the virtual image for superimposition such that the position of the vehicle image in the virtual image for superimposition is closer to the corrected integrated position as the distance measurement value increases, and correct the position of the vehicle image in the virtual image for superimposition such that the position of the vehicle image in the virtual image for superimposition is closer to the integrated position as the distance measurement value decreases. The display control unit 12 may use another formula that has a constant part or an increasing section instead of a monotonically decreasing formula, and may switch whether to correct the position of the vehicle image according to a comparison result of the distance measurement value to another vehicle obtained by using the radar sensors 1b, 1c with a predetermined threshold value. In short, the display control unit 12 may correct the position of the vehicle image using the distance measurement values to other vehicles using the radar sensors 1b, 1c.

What is claimed is:

1. A display device comprising:
a recognition generation unit that performs vehicle recognition based on detection results of a camera that captures an image ahead of an own vehicle and a radar sensor that detects objects around the own vehicle, and generates a virtual image for superimposition including a vehicle image representing another vehicle ahead of the own vehicle recognized by the vehicle recognition; and
a display control unit that displays the virtual image for superimposition on a display unit of the own vehicle,
wherein the recognition generation unit:
calculates an image recognition position that is a position of the vehicle image in the virtual image for superimposition, by using a position of the other vehicle in the image captured by the camera,
calculates an integrated position that is a position of the vehicle image in the virtual image for superimposition and is also a corresponding position on a predetermined plane on which the own vehicle is present, by using detection results of both the camera and the radar sensor, and
calculates a corrected integrated position that is the position of the vehicle image in the virtual image for superimposition and that also corresponds to an actual position of the other vehicle relative to the own vehicle, by correcting the integrated position so as to make the integrated position closer to the image recognition position, and
wherein the display control unit corrects the position of the vehicle image in the virtual image for superimposition based on a distance measurement value to the other vehicle using the radar sensor, the integrated position, and the corrected integrated position.

2. The display device according to claim 1, wherein the display control unit corrects the position of the vehicle image in the virtual image for superimposition such that the position of the vehicle image in the virtual image for superimposition is closer to the corrected integrated position as the distance measurement value increases, and corrects the position of the vehicle image in the virtual image for superimposition such that the position of the vehicle image in the virtual image for superimposition is closer to the integrated position as the distance measurement value decreases.

3. The display device according to claim 1, wherein the display control unit calculates a virtual road surface gradient along a virtual line connecting the own vehicle and the actual position of the other vehicle relative to the own vehicle based on an intersection angle between the virtual line and the predetermined plane, and corrects the position of the vehicle image in the virtual image for superimposition when the virtual road surface gradient is equal to or less than a predetermined upper limit gradient threshold value.
